(19) United States
(12) Patent Application Publication
(10) Pub. No.: US 2025/0334443 A1
(43) Pub. Date: Oct. 30, 2025

(54) DEVICE FOR ESTIMATING MASS OF A VEHICLE AND A VEHICLE INCLUDING THE SAME

(71) Applicants: HYUNDAI MOTOR COMPANY, Seoul (KR); KIA CORPORATION, Seoul (KR); Korea University Of Technology And Education Industry-University Cooperation Foundation, Cheonan-si (KR)

(72) Inventors: Young Sik Yoon, Suwon-si (KR); Rae Wook Chung, Yongin-si (KR); Dong Hyun Hwang, Hwaseong-si (KR); Wan Ki Cho, Suwon-si (KR); Seung Han You, Seoul (KR)

(73) Assignees: HYUNDAI MOTOR COMPANY, Seoul (KR); KIA CORPORATION, Seoul (KR); Korea University Of Technology And Education Industry-University Cooperation Foundation, Cheonan-si (KR)

(21) Appl. No.: 18/910,517

(22) Filed: Oct. 9, 2024

(30) Foreign Application Priority Data
Apr. 30, 2024 (KR) 10-2024-0057511

(51) Int. Cl. G01G 19/03

(52) U.S. Cl. CPC G01G 19/03

(57) ABSTRACT

A device for estimating a mass of a vehicle includes a computing device having a processor and a storage medium on which one or more programs configured to be executable by the processor are recorded. The one or more programs include instructions for executing an operation of estimating a suspension pitch angle of the vehicle, an operation of correcting a longitudinal acceleration value sensed by a longitudinal acceleration sensor of the vehicle based on the suspension pitch angle, and an operation of estimating the mass of the vehicle based on a longitudinal acceleration value corrected by the operation of correcting and force received by the vehicle in a longitudinal direction.

### CROSS-REFERENCE TO RELATED APPLICATION(S)

This application claims benefit of and priority to Korean Patent Application No. 10-2024-0057511, filed on Apr. 30, 2024 in the Korean Intellectual Property Office, the disclosure of which is incorporated herein by reference in its entirety.

### BACKGROUND

### 1. Field

The present disclosure relates to a device for estimating a mass of a vehicle and a vehicle including the same.

### 2. Description of Related Art

Recently, with the expansion of autonomous driving vehicles, ride-sharing services, and similar technologies, the safety and reliability of vehicles have become increasingly emphasized, leading to a focus on monitoring the status of vehicles in real time. In detail, information about the weight of a vehicle is a very important variable in many advanced control technologies in vehicles.

In the related art technology for detecting changes in the weight of a vehicle, a sensor that directly senses the weight may be additionally installed, but this may cause an increase in the cost of adding sensors (including the cost of the sensor itself, the cost of linking the sensor to a computing device, and the cost of changing the vehicle structure due to the additional sensor). Additionally, if the vehicle includes a tractor unit and a trailer unit, it may be difficult for a sensor added to the tractor unit to sense changes in the weight of the trailer unit.

The statements in this section merely provide background information related to the present disclosure and may not constitute prior art.

### SUMMARY

An aspect of the present disclosure provides a device for estimating a mass of a vehicle and a vehicle including the same. The device may estimate the mass of a vehicle with high reliability even without directly sensing the mass of the vehicle.

According to an aspect of the present disclosure, a device for estimating a mass of a vehicle includes a computing device including a processor and a storage medium on which one or more programs configured to be executable by the processor are recorded. The one or more programs include instructions for: estimating a suspension pitch angle of the vehicle, correcting a longitudinal acceleration value sensed by a longitudinal acceleration sensor of the vehicle based on the suspension pitch angle, and estimating the mass of the vehicle based on the corrected longitudinal acceleration value and a force received by the vehicle in a longitudinal direction.

According to an aspect of the present disclosure, a device for estimating a mass of a vehicle includes a computing device including a processor and a storage medium on which one or more programs configured to be executable by the processor are recorded. The one or more programs include instructions for: calculating a reference longitudinal force for each change in mass of the vehicle; updating a plurality of weights based on a longitudinal acceleration value of the vehicle and a force received by the vehicle in a longitudinal direction; and estimating the mass of the vehicle by collecting reference longitudinal forces for respective mass changes respectively weighted with the plurality of weights.

According to an aspect of the present disclosure, a vehicle includes the computing device.

### BRIEF DESCRIPTION OF DRAWINGS

The above and other aspects, features, and advantages of the present disclosure should be more clearly understood from the following detailed description, taken in conjunction with the accompanying drawings, in which:

FIGS. 1 and 2 are diagrams illustrating a device for estimating a mass of a vehicle and a vehicle including the same according to an embodiment;

FIG. 3 is a flowchart illustrating operations performed by a device for estimating a mass of a vehicle and a computing device included in a vehicle including the same according to an embodiment;

FIGS. 4 and 5 are diagrams illustrating operations of estimating longitudinal tire force and air resistance in a device for estimating a mass of a vehicle and a vehicle including the same according to an embodiment;

FIG. 6A is a diagram illustrating operations of estimating a suspension pitch angle in a device for estimating a mass of a vehicle according to an embodiment and a vehicle including the same;

FIG. 6B is a diagram illustrating a suspension pitch angle that may be estimated by a device for estimating a mass of a vehicle and a vehicle including the same, according to an embodiment;

FIG. 6C is a diagram illustrating a road surface inclination angle, distinct from the suspension pitch angle of FIG. 6B;

FIG. 7 is a diagram illustrating operations of correction by a device for estimating a mass of a vehicle and a vehicle including the same according to an embodiment;

FIG. 8 is a diagram illustrating operations of estimating a mass of a vehicle by a device for estimating a mass of a vehicle and a vehicle including the same according to an embodiment;

FIG. 9 illustrates that the mass of a vehicle is estimated by collecting reference longitudinal force for each mass change, each weighted by a plurality of weights, in an operation of estimating the mass of a vehicle in a device for estimating a mass of a vehicle and a vehicle including the same according to an embodiment;

FIGS. 10A to 10B are diagrams illustrating simulation conditions for testing mass estimation reliability of a vehicle by a device for estimating a mass of a vehicle and a vehicle including the same according to an embodiment; and

FIGS. 11A to 14C are graphs illustrating simulation results of a device for estimating a mass of a vehicle and a vehicle including the same according to an embodiment.

### DETAILED DESCRIPTION

Since the present disclosure may make various changes and have various embodiments, specific embodiments are illustrated in the drawings and described in detail. However, this is not intended to limit the present disclosure to specific embodiments, and should be understood to include all changes, equivalents, and substitutes included in the spirit and technical scope of the present disclosure.

Terms such as first, second, and the like may be used to describe various components, but the components should not be limited by the terms. The above terms are used only for the purpose of distinguishing one component from another. For example, a first component may be named a second component, and similarly, the second component may also be named a first component without departing from the scope of the present disclosure. The term ‘and/or’ includes any combination of a plurality of related stated items or any of a plurality of related stated items.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

The terms used in the present disclosure are only used to describe specific embodiments and are not intended to limit the present disclosure. Singular expressions include plural expressions unless the context clearly dictates otherwise. In the present disclosure, terms such as “comprise,” “include” and “have” are intended to designate the presence of features, numbers, operations, operations, components, parts, or combinations thereof described in the specification, and it should be understood that this does not exclude in advance the presence or addition of one or more other features, numbers, operations, operations, components, parts, or combinations thereof.

When a component, device, element, or the like of the present disclosure is described as having a purpose or performing an operation, function, or the like, the component, device, or element should be considered herein as being “configured to” meet that purpose or to perform that operation or function.

One of ordinary skill in the art should appreciate that one or more actions and/or operations described herein may be implemented using, among other things, a tangible computer-readable medium comprising computer-executable instructions (e.g., executable software code) executable by a processor. Alternatively, the actions and/or operations may be implemented as software code, firmware code, specifically configured hardware or processors, and/or a combination of the aforementioned. For example, the vehicle may include a processor specifically configured or otherwise, that controls the overall operation of the vehicle.

In an alternative embodiment, dedicated or otherwise specifically configured hardware implementations, such as application specific integrated circuits, programmable logic arrays and other hardware devices such as specifically configured hardware or processors, can be constructed to implement one or more of the operations described herein.

Unless otherwise defined, all terms used herein, including technical or scientific terms, have the same meaning as that which would be generally understood by a person of ordinary skill in the technical field to which the present disclosure pertains. Terms defined in commonly used dictionaries should be interpreted as having meanings consistent with the meanings they have in the context of the relevant technology, and unless explicitly defined in this application, are not to be interpreted in an idealistic or overly formal sense.

In the present disclosure, the term “vehicles” (including electric vehicles) refers to various types of vehicles used to transport objects, such as people, animals, goods, or the like, from a starting point to a destination. These vehicles are not limited to vehicles traveling on roads or tracks.

Hereinafter, some embodiments of the present disclosure are described in more detail with reference to the attached drawings.

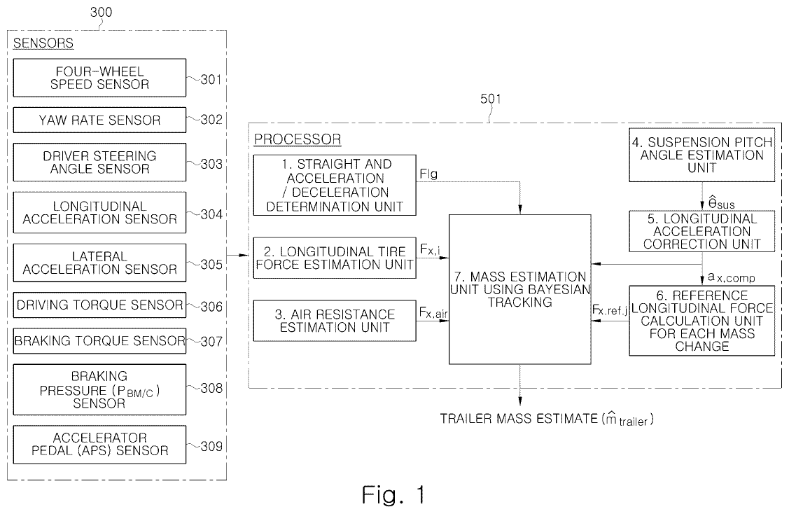

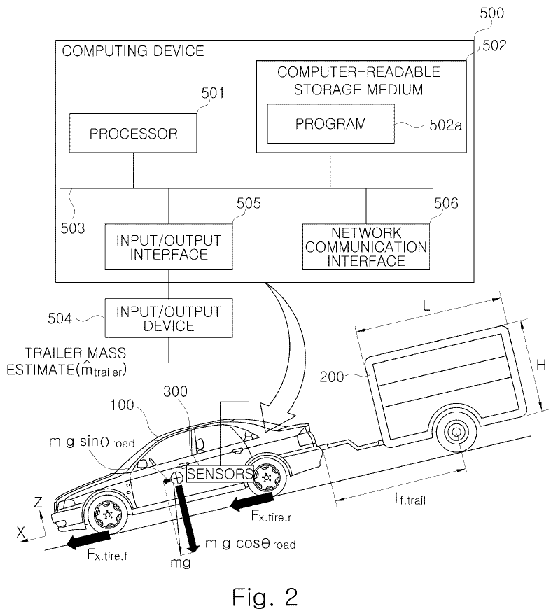

Referring to FIGS. 1 and 2, a device for estimating a mass of a vehicle according to an embodiment may include a computing device 500 and/or sensors 300, and the computing device 500 and/or the sensors 300 may be included in a vehicle.

In one embodiment, the vehicle may include a tractor unit 100 and a trailer unit 200, and the tractor unit 100 may include the computing device 500 and/or the sensors 300. The tractor unit 100 and the trailer unit 200 may be physically connected to or separated from each other through user manipulation. For example, the tractor unit 100 and the trailer unit 200 may be connected to each other by a connecting rod having a predetermined length (lf, trail), and whether or not the connecting rod is connected may be switched by a user's manipulation. The tractor unit 100 may generate a driving force that rotates the wheels and a steering force that controls the direction of the wheels. The trailer unit 200 may move depending on the driving force and steering force generated by the tractor unit 100. The tractor unit 100 may be driven while connected to a trailer unit 200, or may be driven separately from the trailer unit 200.

When the tractor unit 100 and the trailer unit 200 are separated from each other, the mass of the vehicle may be substantially the same as the mass of the tractor unit 100. When the tractor unit 100 and the trailer unit 200 are connected to each other, the mass of the vehicle may be substantially equal to the sum of the masses of the tractor unit 100 and the trailer unit 200. Accordingly, the mass of the vehicle may vary depending on whether the tractor unit 100 and the trailer unit 200 are connected. In addition, the type of trailer unit 200 that may be connected to the tractor unit 100 may not be limited to one type, and the mass of the trailer unit 200 may vary depending on the type or size (for example, the product of length (L) and height (H)) of the trailer unit 200, and may vary depending on the items mounted on the trailer unit 200. The total amount of items that may be mounted on the trailer unit 200 may vary depending on the type or size of the trailer unit 200 (for example, the product of length (L) and height (H)). Accordingly, the mass of the vehicle including the tractor unit 100 to which various trailer units 200 may be connected may have large variations and characteristics that are difficult to predict.

The sensors 300 may include at least one of a four-wheel speed sensor 301, a yaw rate sensor 302, a driver steering angle sensor 303, a longitudinal acceleration sensor 304, a lateral acceleration sensor 305, a driving torque sensor 306, a braking torque sensor 307, a braking pressure (P_{bM/C}) sensor 308, or an accelerator pedal (APS) sensor 309. The four-wheel speed sensor 301 may sense the wheel speed of four wheels, the yaw rate sensor 302 may sense the horizontal rotation of the vehicle, the driver steering angle sensor 303 may sense the driver's steering wheel rotation, the longitudinal acceleration sensor 304 may sense the longitudinal acceleration of the vehicle, the lateral acceleration sensor 305 may sense the lateral acceleration of the vehicle, the driving torque sensor 306 may sense the torque applied to the wheels when the vehicle accelerates, the braking torque sensor 307 may sense the torque applied to the wheels when the vehicle decelerates, the braking pressure (P_{bM/C}) sensor 308 may sense the pressure during braking to decelerate the vehicle, and the accelerator pedal (APS) sensor 309 may sense the driver's pedal input.

A processor 501 of the computing device 500 may, as logic blocks, include a straight and acceleration/deceleration determination unit 1, a longitudinal tire force estimation unit 2, an air resistance estimation unit 3, a suspension pitch angle estimation unit 4, a longitudinal acceleration correction unit 5, a reference longitudinal force calculation unit 6 for each mass change, and a mass estimation unit 7 using Bayesian tracking. The processor 501 of the computing device 500 may generate a mass estimate of the trailer unit.

Equation 1 below provides equations to describe the principle by which a device for estimating a mass of a vehicle and a vehicle including the same correct the longitudinal acceleration value according to an embodiment.

$$m {a}_{x} = m ( {\dot{V}}_{x} - {V}_{y} γ ) = {F}_{x . FL} + {F}_{x . FR} + {F}_{x . RL} + {F}_{x . RR} + {F}_{x . air} + m g {θ}_{road} \\ {a}_{x} : actual longitudinal acceleration \\ {F}_{x . FL} + {F}_{x . FR} + {F}_{x . RL} + {F}_{x . RR} : \\ tire longitudinal force generated by braking / driving torque \\ {F}_{x . air} : air resistance \\ m g {θ}_{road} : longitudinal force by road surface slope \\ {a}_{x . CAN} = {\dot{V}}_{x} - {Y}_{y} γ - g ( {θ}_{sus} + {θ}_{road} ) \\ {a}_{x . CAN} : \\ acceleration measured by longitudinal acceleration sensor \\ {θ}_{sus} : suspension pitch angle \\ {θ}_{road} : road surface pitch angle \\ m ( {a}_{x . CAN} - g ( {θ}_{sus} + {θ}_{road} ) ) = {F}_{x . FL} + {F}_{x . FR} + {F}_{x . RL} + {F}_{x . RR} + {F}_{x . air} + m g {θ}_{road} \\ m ( {a}_{x . CAN} - g {θ}_{sus} ) = {F}_{x . FL} + {F}_{x . FR} + {F}_{x . RL} + {F}_{x . RR} + {F}_{x . air} \qquad [ Equation 1 ]$$

Referring to Equation 1, the product (force received by the vehicle) of the mass of the vehicle (m) and the actual longitudinal acceleration (aₓ) of the vehicle may be a product of the differential value of the mass of the vehicle (m) and the speed of the vehicle, and may be a sum of tire longitudinal force (F_{x.FL}+F_{x.FR}+F_{x.RL}+F_{x.RR}) generated by braking/driving torque, air resistance (F_{x.air}) and longitudinal force (mgθ_{road}) by road surface slope.

The longitudinal acceleration value (a_{x.CAN}) sensed by the longitudinal acceleration sensor (304 in FIG. 1) of the vehicle may be a value obtained by subtracting a gravity factor from a differential value of the vehicle speed. In this case, the gravity factor may include the product of the suspension pitch angle (θₛᵤₛ) and the gravitational acceleration (g) and the product of the road surface pitch angle (θ_{road}) and the gravitational acceleration (g).

In detail, the difference between the actual longitudinal acceleration (aₓ) and the sensed longitudinal acceleration value (a_{x.CAN}) may be the product of the suspension pitch angle (θₛᵤₛ) and the gravitational acceleration (g), and the differential value of the vehicle speed and the road surface pitch angle (θ_{road}) may be eliminated in the calculation process.

Therefore, the value obtained by adding the sensed longitudinal acceleration value (a_{x.CAN}) to the product of the suspension pitch angle (θₛᵤₛ) and the gravitational acceleration (g) may be the actual longitudinal acceleration (aₓ) of the vehicle, and may be used as a denominator when estimating the mass (m) of a vehicle. When estimating the vehicle mass (m), the numerator may be a sum of the tire longitudinal force (F_{x.FL}+F_{x.FR}+F_{x.RL}+F_{x.RR}) and the air resistance force (F_{x.air}).

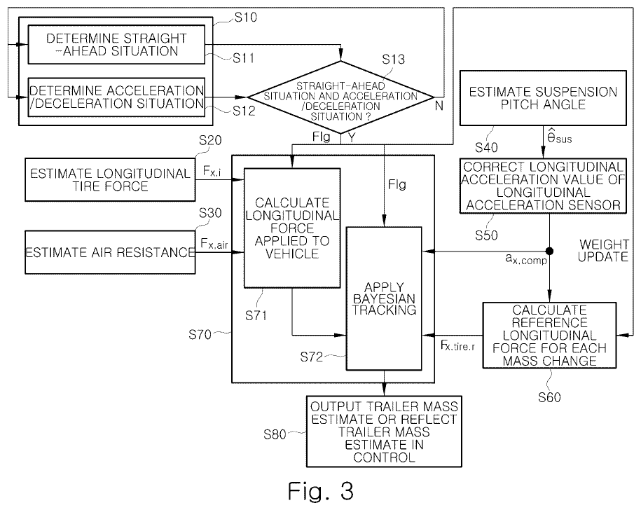

Referring to FIG. 3, a device for estimating a mass of a vehicle according to an embodiment may execute, by the computing device (500 in FIG. 2), an operation (S40) of estimating the suspension pitch angle (θₛᵤₛ) of the vehicle, an operation (S50) of correcting the longitudinal acceleration value (a_{x.CAN} in Equation 1) sensed by the longitudinal acceleration sensor of the vehicle, based on the suspension pitch angle (θₛᵤₛ), and an operation (S70, S71, S72) of estimating the mass of the vehicle based on the longitudinal acceleration value (a_{x,comp}) corrected by the correction operation and the force (for example, the sum of F_{x,i} and F_{x,air}) received by the vehicle in the longitudinal direction.

Compared to the longitudinal acceleration value (aₓ. CAN in Equation 1) sensed by the acceleration sensor, the corrected longitudinal acceleration value (a_{x,comp}) may be closer to the actual longitudinal acceleration (aₓ in Equation 1), and thus, the mass estimated based on the corrected longitudinal acceleration value (a_{x,comp}) may have relatively high reliability. Therefore, the device for estimating a mass of a vehicle according to an embodiment of the present disclosure may estimate the mass of the vehicle with high reliability even without directly sensing the mass of the vehicle.

Referring to FIG. 3, a device for estimating a mass of a vehicle according to an embodiment may execute, by the computing device (500 in FIG. 2), an operation (S60) of calculating the reference longitudinal force (F_{x.ref.j}) for each change in mass of the vehicle, and an operation (S70) of updating a plurality of weights (wₖ in Equation 3) based on the longitudinal acceleration value (for example, a_{x.CAN} in Equation 1 or a_{x,comp} in FIG. 3) of the vehicle and the force (for example, the sum of F_{x,i} and F_{x,air}) experienced by the vehicle in the longitudinal direction, and estimating the mass of the vehicle by collecting the reference longitudinal force (F_{x.ref.j}) for respectively weighted mass changes of the plurality of weights.

Compared to the single reliability of each of the longitudinal acceleration value (for example, a_{x.CAN} in Equation 1 or a_{x,comp} in FIG. 3) of the vehicle and the longitudinal force (for example, the sum of F_{x,i} and F_{x,air}) experienced by the vehicle, since the plurality of weights (wₖ in Equation 3) continuously influenced by the longitudinal acceleration value (for example, aₓ. CAN in Equation 1 or a_{x,comp} in FIG. 3) of the vehicle and the force (for example, the sum of F_{x,i} and F_{x,air}) experienced by the vehicle in the longitudinal direction may have relatively higher reliability, the mass estimated based on the plurality of weights (wₖ in Equation 3) may have high reliability. Therefore, the device for estimating a mass of a vehicle according to an embodiment may estimate the mass of the vehicle with high reliability even without directly sensing the mass of the vehicle.

Depending on the design, a device for estimating a mass of a vehicle according to an embodiment may further execute an operation (S80) of outputting the mass estimation value or reflecting the mass estimation value in control by the computing device (500 in FIG. 2). For example, the computing device (500 in FIG. 2) may output a mass estimate value to at least one of the vehicle's electronic control unit, an engine control unit, a transmission control unit, an Engine Management System Electronic Control Unit (EMS ECU), a Transmission Management System Electronic Control Unit (TMS ECU) or an Anti-locking Brake System Electronic Control Unit (ABS ECU). Alternatively, the computing device may control the steering angle of the rear wheels of the tractor unit (100 in FIG. 2) based on the mass estimate value.

Referring to FIGS. 1, 3, and Equation 2 below, the device for estimating a mass of a vehicle according to an embodiment may further execute an operation S10. The operation S10 includes an operation of determining a straight-ahead situation of the vehicle (an operation S11) and an acceleration/deceleration situation of the vehicle (an operation S12) by the computing device (500 in FIG. 2), and the device may use Equation 2 below, but the present disclosure is not limited thereto.

$$1 - 1. straight - ahead situation determination flag \\ If min ( {WS}_{FL} , … {WS}_{RR} ) \geq Δ WS \&\& \\ \vert {δ}_{f} \vert \leq {Δδ}_{f} \&\& \vert γ \vert \leq Δγ \&\& \vert {a}_{y} \vert \leq Δ {a}_{y} \\ {Flg}_{1} = 1 Straight - ahead state \\ when it is a predetermined speed or more , \\ and driver steering angle , yaw rate and lateral \\ acceleration are all a predetermined value or less \\ else {Flg}_{1} = 0 \\ 1 - 2. acceleration / deceleration situation determined flag \\ If min ( {WS}_{FL} , … {WS}_{RR} ) \geq Δ WS \&\& \\ APS \leq Δ APS \&\& {P}_{b . M / C} \leq Δ {P}_{b . M / C} \\ {Flg}_{2} = 0 Constant speed driving state ( not acceleration / \\ deceleration ) state when it is a predetermined speed or more \\ and the accelerator pedal has a predetermined value or less \\ and the braking pressure has a predetermined value or less \\ else {Flg}_{2} = 1 \\ Flg = {Flg}_{1} * {Flg}_{2} \\ Flg : straight accelaration / deceleration determination flag \\ {Flg}_{1} : straight determination flag \\ {Flg}_{2} : acceleration / deceleration determination flag \\ {WS}_{i} : each wheel speed [ kph ] , i = FL , FR , RL , RR \\ {δ}_{f} : driver steering angle [ deg ] \\ {Δδ}_{f} : straight determination \\ driver steering angle Threshold ( = 5 deg ) \\ {P}_{b . M / C} : Master cylinder pressure [ bar ] \\ γ : vehicle yaw rate [ \text{deg/} sec ] \\ Δγ : straight determination lateral \\ acceleration Threshold ( = 2 \text{deg/} sec ) \\ {a}_{y} : vehicle lateral acceleration [ mpss ] \\ Δ {a}_{y} : straight determination \\ lateral acceleration Threshold ( = 0.2 mpss ) \\ APS : driver accelerator pedal [ \% ] \\ Δ APS : acceleration / \\ deceleration determination driver Threshold ( = 5 \% ) \\ Δ {P}_{b . M / C} : acceleration / deceleration determined \\ master cylinder pressure threshold ( = 5 bar ) \qquad [ Equation 2 ]$$

The straight and acceleration/deceleration determination unit 1 of the computing device (500 in FIG. 2) may assign 1 to the straight-ahead situation value Flg₁ when the sensing value of the four-wheel speed sensor 301 is a predetermined speed or more, the sensing value of the yaw rate sensor 302 is a predetermined value or less, the sensing value of the driver steering angle sensor 303 is a predetermined value or less, and the sensing value of the lateral acceleration sensor 305 is a predetermined value or less. Otherwise, the computing device (500 in FIG. 2) may assign 0 to the straight-ahead situation value (Flg₁).

The straight and acceleration/deceleration determination unit 1 of the computing device (500 in FIG. 2) may assign 0 to the acceleration/deceleration situation value Flg₂, when the sensing value of the four-wheel speed sensor 301 is a predetermined speed or more, the sensing value of the accelerator pedal (APS) sensor 309 is a predetermined value or less and the sensing value of the braking pressure (P_{bM/C}) sensor 308 is a predetermined value or less. Otherwise, the computing device (500 in FIG. 2) may assign 1 to the acceleration/deceleration situation value (Flg₂).

Afterwards, the straight and acceleration/deceleration determination unit 1 of the computing device (500 in FIG. 2) may assign (in an operation S13) the value obtained by multiplying the straight-ahead situation value (Flg₁) and the acceleration/deceleration situation value (Flg₂) to the straight and acceleration/deceleration value (Flg).

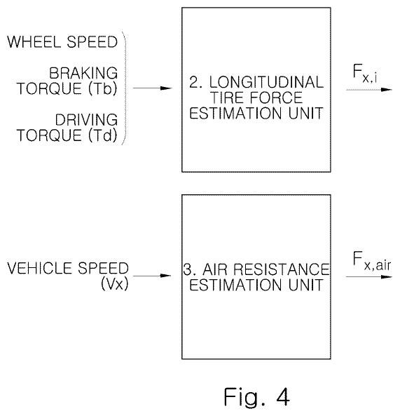

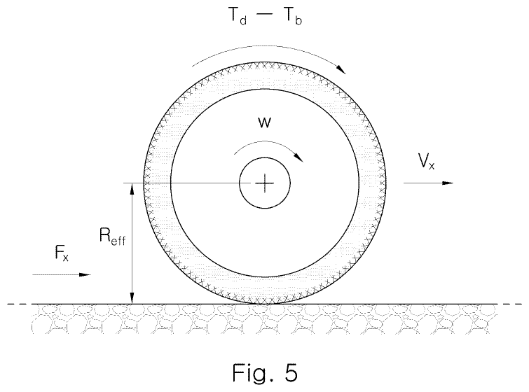

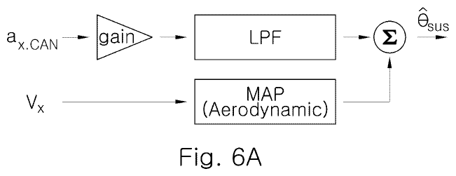

Referring to FIGS. 1, 3, 4, and 5, a device for estimating a mass of a vehicle according to an embodiment may perform an operation (S20) of estimating the longitudinal tire force (F_{x,i}) of the vehicle and an operation (S30) of estimating the air resistance (F_{x,air}) of the vehicle by the computing device (500 in FIG. 2). The force experienced by the vehicle in the longitudinal direction may be a sum of the longitudinal tire force (F_{x,i}) of the vehicle and the air resistance (F_{x,air}) of the vehicle.

The longitudinal tire force estimation unit 2 of the computing device (500 in FIG. 2) may estimate the longitudinal tire force (F_{x,i}) of the vehicle, based on the wheel speed value sensed by the four-wheel speed sensor 301 of the vehicle, the driving torque value (Td) sensed by the driving torque sensor 306 of the vehicle, and the braking torque value (Tb) sensed by the braking torque sensor 307 of the vehicle. The air resistance estimation unit 3 of the computing device (500 in FIG. 2) may include estimating the air resistance (F_{x,air}) of the vehicle based on a vehicle speed (Vₓ). The vehicle speed (Vₓ) may be equal to the speed of the wheels. The longitudinal tire force (F_{x,i}) of the vehicle may be derived by the dynamic model of the wheel.

Referring to FIGS. 1, 3, and 6A, the operation (S40) of estimating the suspension pitch angle, which may be executed by the suspension pitch angle estimation unit 4 of the computing device (500 in FIG. 2), may include estimating the suspension pitch angle (θₛᵤₛ) by collecting a value correspond to the vehicle speed (Vₓ) in corresponding values for respective vehicle speeds in the prestored map (MAP) and a value obtained by applying gain to the longitudinal acceleration value (a_{x.CAN}) sensed by the longitudinal acceleration sensor of the vehicle and applying a low-pass filter (LPF) thereto. The low-pass filter (LPF) may be applied to match the phase difference between the sensed longitudinal acceleration value (a_{x.CAN}) and the vehicle speed (Vₓ). The prestored map (MAP) may store corresponding values for multiple speeds, and the correspondence between the values may be determined by experimenting with an actual vehicle. The suspension pitch angle (θₛᵤₛ) may be based on the principle generated by air resistance due to the vehicle speed (Vₓ).

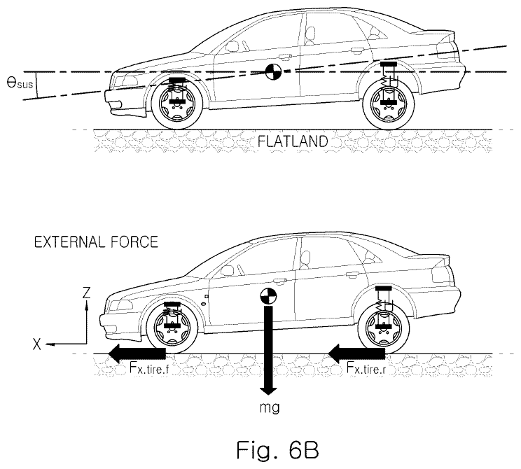

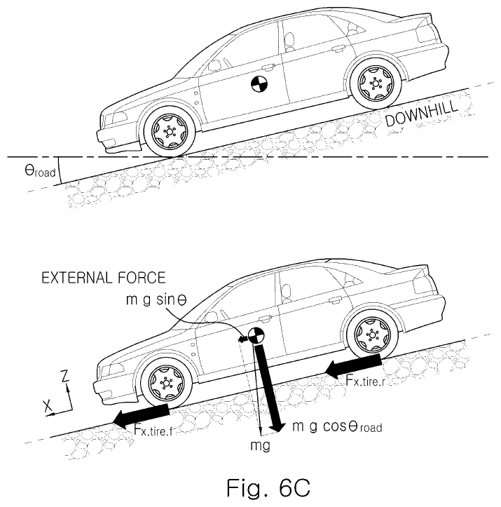

Referring to FIG. 6B, the suspension pitch angle (θₛᵤₛ) may be an angle between the road surface supporting the tires of the vehicle and the suspension of the vehicle. Referring to FIG. 6C, the road surface inclination angle (θ_{road}) may be an angle between the road surface supporting the tires of the vehicle and the direction of gravity. The road surface inclination angle (θ_{road}) may be an unknown value, but the calculation process of Equation 1 may eliminate the road surface inclination angle (θ_{road}).

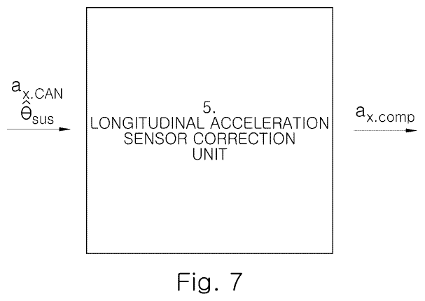

Referring to FIGS. 1, 3, and 7, the correction operation (S50) that may be executed by the longitudinal acceleration correction unit 5 of the computing device (500 in FIG. 2) may include correction by adding the product of the suspension pitch angle (θₛᵤₛ) and the gravitational acceleration (g in Equation 1) to the longitudinal acceleration value (a_{x.CAN} in Equation 1) sensed by the longitudinal acceleration sensor of the vehicle.

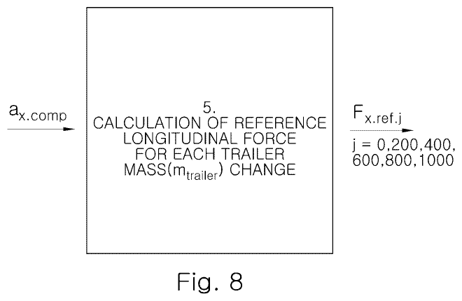

Referring to FIGS. 1, 3 and 8, in the operation (S60) of calculating the reference longitudinal force (F_{x.ref.j}) for each mass change of the vehicle, which may be executed by the reference longitudinal force calculation unit 6 for each mass change of the computing device (500 in FIG. 2), the reference longitudinal force (F_{x.ref.0}) when the trailer mass (mₜᵣₐᵢₗₑᵣ) is 0 kg, the reference longitudinal force (F_{x.ref.200}) when the trailer mass (mₜᵣₐᵢₗₑᵣ) is 200 kg, the reference longitudinal force (F_{x.ref.400}) when the trailer mass (mₜᵣₐᵢₗₑᵣ) is 400 kg, the reference longitudinal force (F_{x.ref.600}) when the trailer mass (mₜᵣₐᵢₗₑᵣ) is 600 kg, the reference longitudinal force (F_{x.ref.800}) when the trailer mass (mₜᵣₐᵢₗₑᵣ) is 800 kg, and the reference longitudinal force (F_{x.ref.1000}) when the trailer mass (mₜᵣₐᵢₗₑᵣ) is 1000 kg, may be calculated. The mass of the vehicle may be the sum of the trailer mass (mₜᵣₐᵢₗₑᵣ) and the tractor mass (mtractor), the trailer mass (mₜᵣₐᵢₗₑᵣ) may be a variable, and the tractor mass (Mtractor) may be a constant. For example, the reference longitudinal force (F_{x.ref.j}) for each vehicle mass change may be determined by testing an actual vehicle and stored in advance in the computing device (500 in FIG. 2).

Referring to FIGS. 1, 3, and 9, the operation (S70) of estimating the mass, which may be executed by the mass estimation unit 7 using Bayesian tracking of the computing device (500 in FIG. 2), may include updating the weight (wₖ) based on the longitudinal acceleration value (a_{x,comp}) corrected by the correction operation (S50) and the force (for example, the sum of F_{x,i} and F_{x,air}) received by the vehicle in the longitudinal direction, and estimating the mass of the vehicle based on the weight (wₖ) and the reference longitudinal force (F_{x.ref.j}) for each mass change, and may use Equation 3 below, but the present disclosure is not limited thereto.

$${\hat{m}}_{trailer} = 0 \cdot {w}_{k}^{0} + 200 \cdot {w}_{k}^{200} + 400 \cdot {w}_{k}^{400} + 600 \cdot {w}_{k}^{600} + 800 \cdot {w}_{k}^{800} + 1000 \cdot {w}_{k}^{1000} \qquad [ Equation 3 ]$$

The weight (wₖ) in Equation 3 may be updated based on Bayesian estimation, Bayesian inference, Bayesian theory, Bayesian updating, or Bayesian probability.

The operation (S70) of estimating the mass may include updating (wₖⁱ=wₖ₋₁ⁱ) the weight (wₖ) when the vehicle is going straight and accelerating/decelerating (Flg=1), and maintaining the weight (wₖ) when the vehicle is neither moving straight, nor accelerating, nor decelerating (Flg=0). Accordingly, the reliability of weight (wₖ) update may be further increased.

The weight (wₖ) is a plurality of weights (wₖ⁰, wₖ²⁰⁰, wₖ⁴⁰⁰, wₖ⁶⁰⁰, wₖ⁸⁰⁰ and wₖ¹⁰⁰⁰) weighted for respective reference longitudinal forces (F_{x.ref.0}, F_{x.ref.200}, F_{x.ref.400}, F_{x.ref.600}, F_{x.ref.800}, and F_{x.ref.1000}) for respective mass changes, and the operation (S70) of estimating the mass may include estimating the mass of the vehicle by collecting the reference longitudinal forces for respective weighted mass changes of the plurality of weights (wₖ⁰, wₖ²⁰⁰, wₖ⁴⁰⁰, wₖ⁶⁰⁰, wₖ⁸⁰⁰, and wₖ¹⁰⁰⁰). The greater the number of the plurality of weights (wₖ⁰, wₖ²⁰⁰, wₖ⁴⁰⁰, wₖ⁶⁰⁰, wₖ⁸⁰⁰, and wₖ¹⁰⁰⁰), the higher the mass estimation reliability may be.

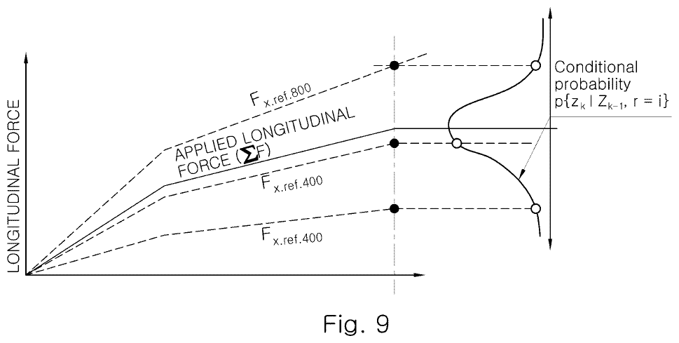

Referring to FIG. 9, assuming that the applied longitudinal force is between F_{x.ref.400} and F_{x.ref.600}, according to the Bayesian probability distribution, wₖ⁴⁰⁰ and wₖ⁶⁰⁰ may be relatively high, wₖ²⁰⁰ and wₖ⁸⁰⁰ may be relatively low, and wₖ⁰ and wₖ¹⁰⁰⁰ may be the lowest.

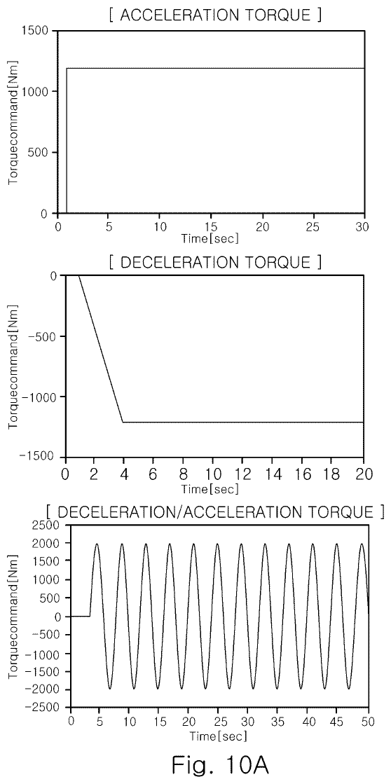

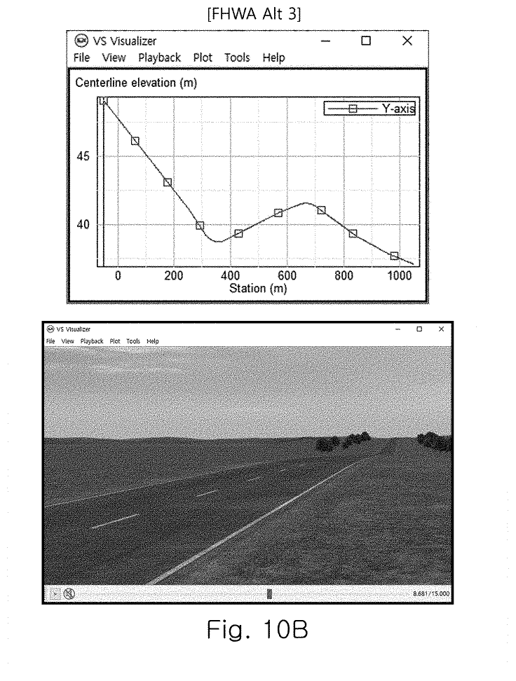

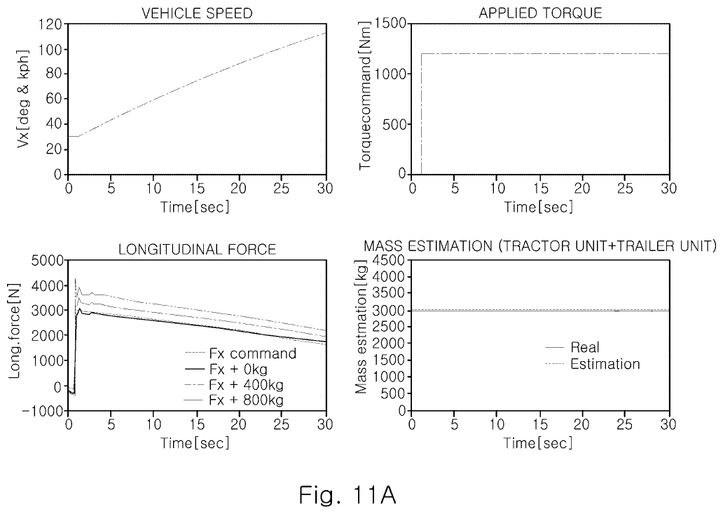

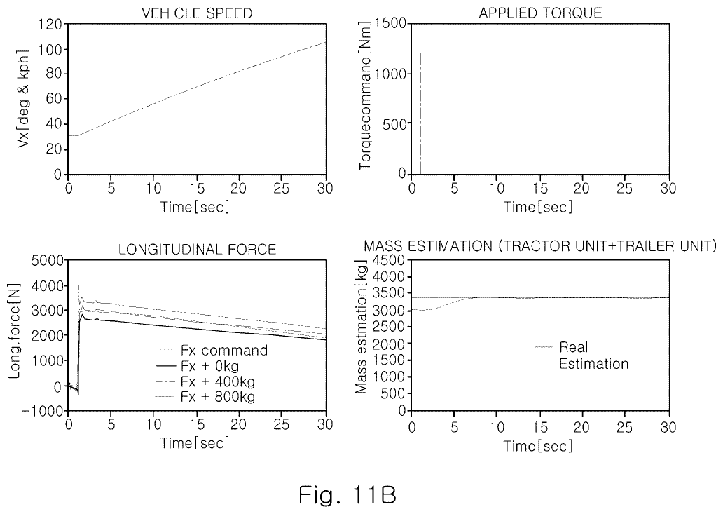

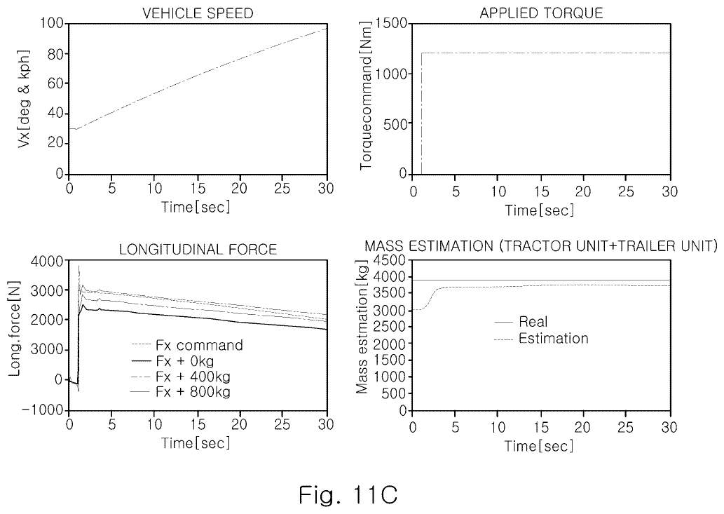

FIG. 10A illustrates a first graph illustrating the torque command value (Torquecommand) according to time in the first case in which the vehicle accelerates, a second graph illustrating the torque command value (Torquecommand) according to time in the second case in which the vehicle decelerates, and a third graph illustrating the torque command value (Torquecommand) according to time in the third case in decelerates/accelerates. FIG. 10B which the vehicle illustrates centerline elevation according to the horizontal station of the terrain in the fourth case in which the vehicle decelerates and decelerates when the vehicle drives on the simulated terrain (FHWA Alt 3). The initial speeds of the first, second, third, and fourth cases are 30 kph, 1000 kph, 50 kph, and 50 kph, respectively, and the road surface of the first, second, and third cases is flat.

FIG. 11A illustrates simulation results of vehicle speed, applied torque, longitudinal force, and mass estimation in the first case when the mass of the trailer unit (200 in FIG. 2) is 0 kg. FIG. 11B illustrates simulation results of vehicle speed, applied torque, longitudinal force, and mass estimation in the first case when the mass of the trailer unit (200 in FIG. 2) is 400 kg. FIG. 11C illustrates simulation results of vehicle speed, applied torque, longitudinal force, and mass estimation in the first case when the mass of the trailer unit (200 in FIG. 2) is 900 kg.

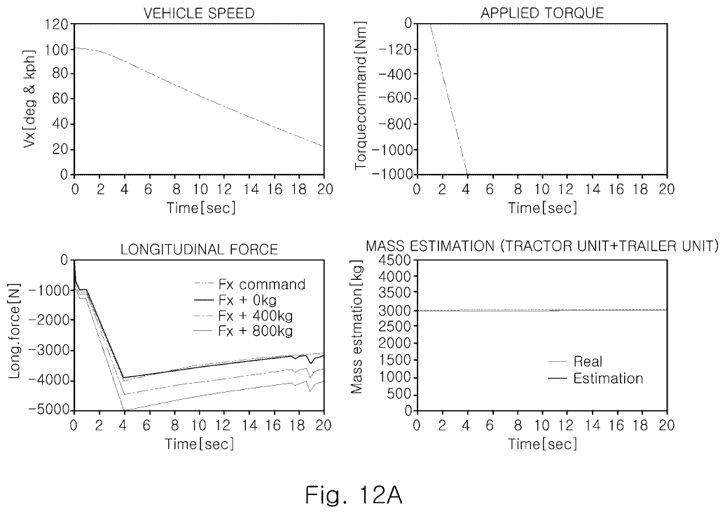

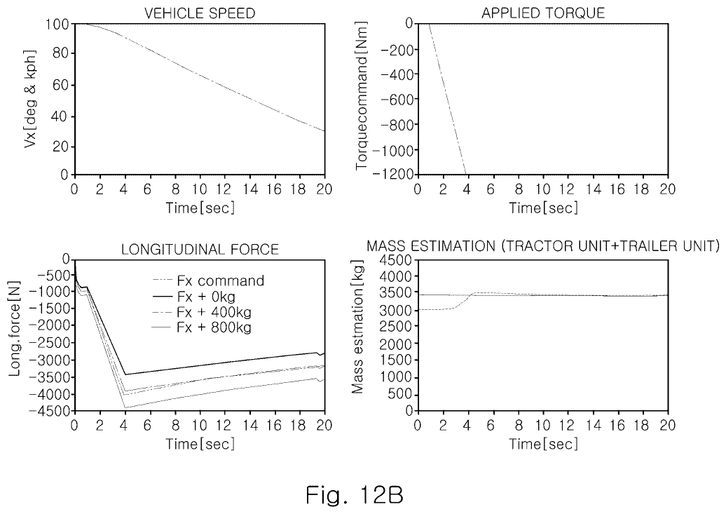

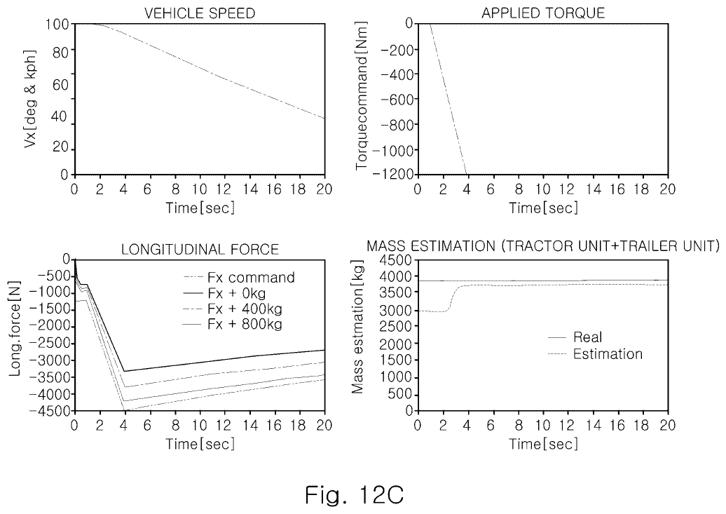

FIG. 12A illustrates simulation results of vehicle speed, applied torque, longitudinal force, and mass estimation in the second case when the mass of the trailer unit (200 in FIG. 2) is 0 kg. FIG. 12B illustrates simulation results of vehicle speed, applied torque, longitudinal force, and mass estimation in the second case when the mass of the trailer unit (200 in FIG. 2) is 400 kg. FIG. 12C illustrates simulation results of vehicle speed, applied torque, longitudinal force, and mass estimation in the second case when the mass of the trailer unit (200 in FIG. 2) is 900 kg.

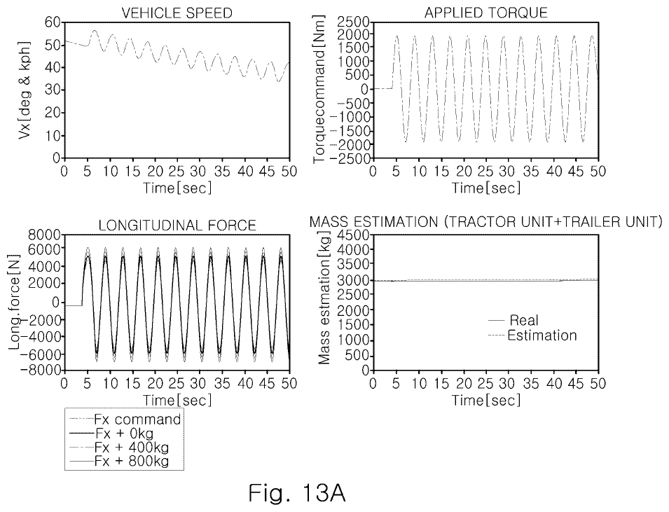

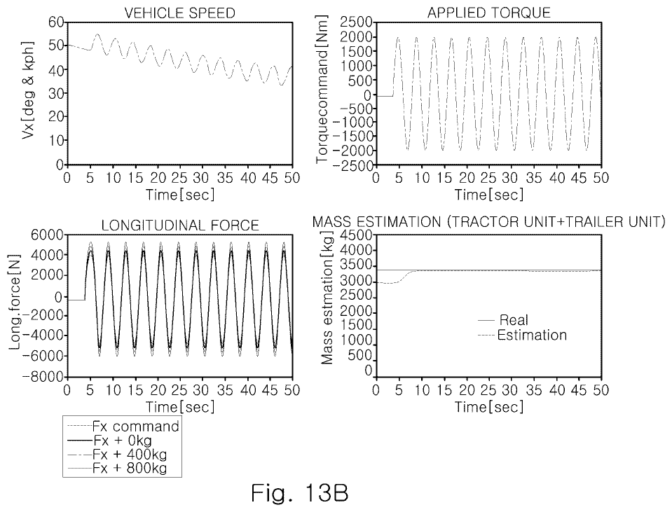

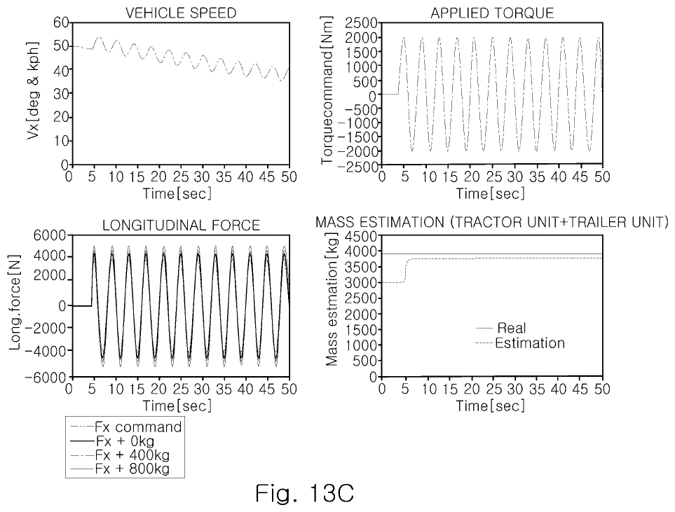

FIG. 13A illustrates simulation results of vehicle speed, applied torque, longitudinal force, and mass estimation in the third case when the mass of the trailer unit (200 in FIG. 2) is 0 kg. FIG. 13B illustrates simulation results of vehicle speed, applied torque, longitudinal force, and mass estimation in the third case when the mass of the trailer unit (200 in FIG. 2) is 400 kg. FIG. 13C illustrates simulation results of vehicle speed, applied torque, longitudinal force, and mass estimation in the third case when the mass of the trailer unit (200 in FIG. 2) is 900 kg.

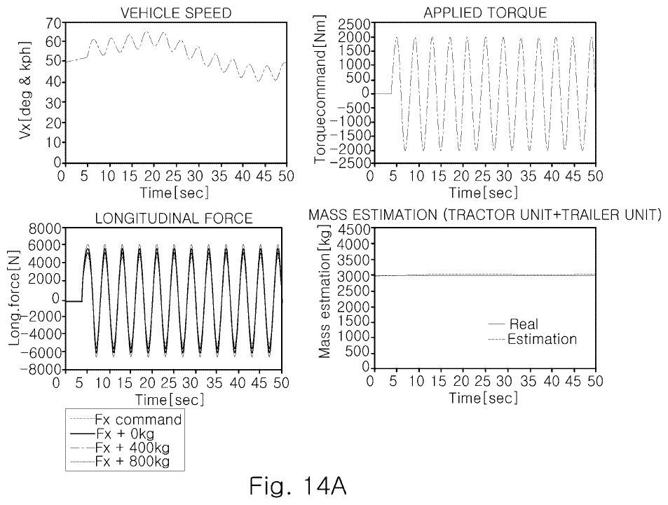

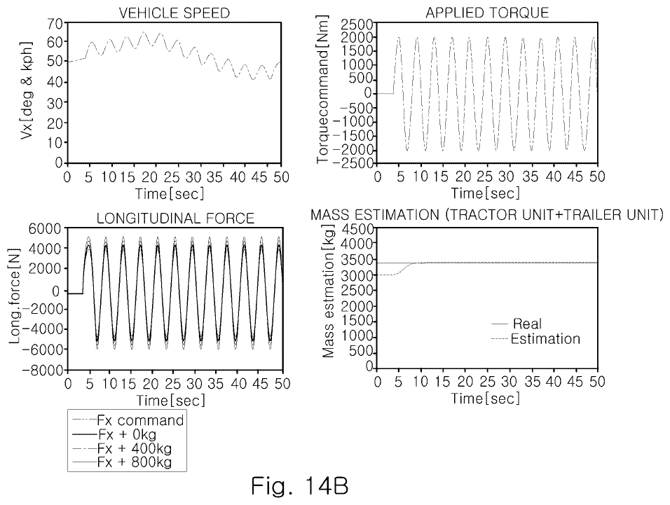

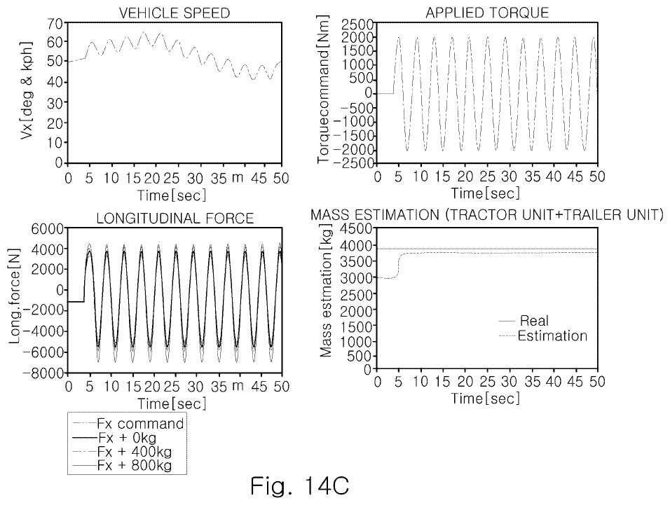

FIG. 14A illustrates simulation results of vehicle speed, applied torque, longitudinal force, and mass estimation in the fourth case when the mass of the trailer unit (200 in FIG. 2) is 0 kg. FIG. 14B illustrates simulation results of vehicle speed, applied torque, longitudinal force, and mass estimation in the fourth case when the mass of the trailer unit (200 in FIG. 2) is 400 kg. FIG. 14C illustrates simulation results of vehicle speed, applied torque, longitudinal force, and mass estimation in the fourth case when the mass of the trailer unit (200 in FIG. 2) is 900 kg.

In FIGS. 11A-14C, the Fx command is the simulation intermediate value (longitudinal force) of the device for estimating a mass of a vehicle according to an embodiment, Fx command+0 kg is the actual measured value when the mass of the trailer unit (200 in FIG. 2) is 0 kg, Fx command+400 kg is the actual measured value when the mass of the trailer unit (200 in FIG. 2) is 400 kg, Fx command+800 kg is the actual measured value when the mass of the trailer unit (200 in FIG. 2) is 800 kg, the mass of the tractor unit is 3000 kg, real is an actual measured value, and Estimation is a simulation result value (a mass estimation value) of a device for estimating a mass of a vehicle according to an embodiment. Since FIGS. 11A-14C illustrate that all mass estimates (Estimation) quickly track the actual measured values (real), the device for estimating a mass of a vehicle according to an embodiment may estimate the vehicle mass with high reliability.

Meanwhile, referring to FIG. 2, the device for estimating a mass of a vehicle according to an embodiment may include a computing device 500 disposed in a vehicle (for example, tractor unit 100 and/or trailer unit 200), and the computing device 500 may include at least one processor 501, a computer-readable storage medium 502, and a communication bus 503. The communication bus 503 may interconnect various other components of the computing device 500, including the processor 501 and the computer-readable storage medium 502.

The processor 501 may enable the computing device 500 to operate according to the above-mentioned example embodiments. For example, the processor 501 may execute one or more programs stored in the computer-readable storage medium 502. The one or more programs may include one or more computer executable instructions, and the computer-executable instructions, when executed by the processor 501, may be configured to cause the computing device 500 to perform operations according to example embodiments.

The computer-readable storage medium 502 may be configured to store computer-executable instructions or program code, program data, and/or other suitable forms of information. A program 502a stored in the computer-readable storage medium 502 includes a set of instructions executable by the processor 501. In an embodiment, the computer-readable storage medium 502 may be a memory (a volatile memory, such as a random access memory, a non-volatile memory, or an appropriate combination thereof), one or more magnetic disk storage devices, optical disk storage devices, flash memory devices, other types of storage media that may be accessed by the computing device 500 and store required information, or suitable combinations thereof.

The computing device 500 may also include one or more input/output interfaces 505 and one or more network communication interfaces 506 that provide an interface for one or more input/output devices 504. The input/output interface 505 and the network communication interface 506 are connected to the communication bus 503. The network may be a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), a Universal Mobile Telecommunications System (UMTS), Long Term Evolution (LTE), 5G, Wi-Fi, or any one of other cellular networks, and may also be implemented as Ethernet, Media Oriented Systems Transport (MOST), Flexray, Controller Area Network (CAN), Local Interconnect Network (LIN), Internet, Bluetooth, NFC (Near Field Communication), Zigbee®, Radio Frequency (RF), or the like.

The input/output device 504 may be connected to other components of the computing device 500 through the input/output interface 505. Examples of the input/output device 504 may include input devices such as pointing devices (such as a mouse or trackpad), keyboards, touch input devices (such as a touchpad or touch screen), voice or sound input devices, various types of sensor devices and/or imaging devices, and/or output devices such as display devices, printers, speakers, and/or network cards. As an example, the input/output device 504 may be included within the computing device 500 as a component constituting the computing device 500, or may be connected to the computing device 500 as a separate device distinct from the computing device 500.

Meanwhile, embodiments may include a program for performing the methods described in this specification on a computer, and a computer-readable recording medium containing the program. The computer-readable recording medium may include program instructions, local data files, local data structures, and the like, singly or in combination. The media may be those specifically designed and constructed for the present disclosure, or may be those commonly available in the computer software field. Examples of the computer-readable recording media include magnetic media such as hard disks, floppy disks, and magnetic tapes, optical recording media such as CD-ROM and DVD, and a specially configured hardware device to store and perform program instructions, such as ROM, RAM, flash memory, and the like. Examples of the programs may include not only machine language code such as that produced by a compiler, but also high-level language code that may be executed by a computer using an interpreter, or the like.

As set forth above, a device for estimating a mass of a vehicle and a vehicle including the same according to an embodiment may estimate the mass of the vehicle with high reliability even without directly sensing the mass of the vehicle. For example, in a device for estimating a mass of a vehicle and a vehicle including the same, changes in the mass of a trailer unit may be effectively estimated and vehicle control stability and reliability may be improved.

While some embodiments have been illustrated and described above, it should be apparent to those having ordinary skill in the art that modifications and variations could be made without departing from the scope of the present inventive concept as defined by the appended claims.

What is claimed is:

1. A device for estimating a mass of a vehicle comprising:
a computing device including a processor and a storage medium on which one or more programs configured to be executable by the processor are recorded,
wherein the one or more programs include instructions for: estimating a suspension pitch angle of the vehicle,
correcting a longitudinal acceleration value sensed by a longitudinal acceleration sensor of the vehicle based on the suspension pitch angle, and
estimating the mass of the vehicle based on the corrected longitudinal acceleration value and a force received by the vehicle in a longitudinal direction.

2. The device of claim 1, wherein estimating the suspension pitch angle includes estimating the suspension pitch angle by collecting a value corresponding to an actual speed of the vehicle in values corresponding to respective speeds of the vehicle in a prestored map, and a value obtained by applying a low-pass filter to the longitudinal acceleration value sensed by the longitudinal acceleration sensor of the vehicle.

3. The device of claim 1, wherein correcting the longitudinal acceleration value includes correcting by adding a product of the suspension pitch angle and a gravitational acceleration to the longitudinal acceleration value sensed by the longitudinal acceleration sensor of the vehicle.

4. The device of claim 1, wherein the suspension pitch angle is an angle between a road surface supporting tires of the vehicle and a suspension of the vehicle.

5. The device of claim 1, wherein the one or more programs further include an instruction for estimating a longitudinal tire force of the vehicle and an air resistance of the vehicle, and
the force received by the vehicle in the longitudinal direction includes the longitudinal tire force of the vehicle and the air resistance of the vehicle.

6. The device of claim 5, wherein estimating the longitudinal tire force of the vehicle and the air resistance of the vehicle includes:
estimating the longitudinal tire force of the vehicle, based on a wheel speed value sensed by a four-wheel speed sensor of the vehicle, a driving torque value sensed by a driving torque sensor of the vehicle, and a braking torque value sensed by a braking torque sensor of the vehicle; and
estimating the air resistance of the vehicle based on a speed of the vehicle.

7. The device of claim 1, wherein the one or more programs further include an instruction for calculating a reference longitudinal force for each change in mass of the vehicle, and
estimating the mass includes:
updating a weight based on the corrected longitudinal acceleration value and the force received by the vehicle in the longitudinal direction, and
estimating the mass of the vehicle based on the weight and the reference longitudinal force for each mass change.

8. The device of claim 7, wherein the weight is provided as a plurality of weights weighted for each reference longitudinal force for each mass change, and
estimating the mass includes estimating the mass of the vehicle by collecting the reference longitudinal force for respective mass changes weighted with the plurality of weights.

9. The device of claim 7, wherein the one or more programs further include instructions for determining a straight-ahead situation and an acceleration-deceleration situation of the vehicle, and
estimating the mass includes:
updating the weight when the vehicle is traveling straight and accelerating or decelerating; and
maintaining the weight when the vehicle is neither traveling straight, nor accelerating, nor decelerating.

10. The device of claim 7, wherein the vehicle includes a tractor unit and a trailer unit, and
calculating the reference longitudinal force for each mass change includes calculating the reference longitudinal force for each mass change using a mass of the tractor unit and a mass of the trailer unit as a constant and a variable, respectively.

11. A device for estimating a mass of a vehicle, comprising:
a computing device including a processor and a storage medium on which one or more programs configured to be executable by the processor are recorded,
wherein the one or more programs include instructions for: calculating a reference longitudinal force for each change in mass of the vehicle, and updating a plurality of weights based on a longitudinal acceleration value of the vehicle and a force received by the vehicle in a longitudinal direction, and estimating the mass of the vehicle by collecting reference longitudinal forces for respective mass changes respectively weighted with the plurality of weights.

12. The device of claim 11, wherein the one or more programs further include an instruction for determining a straight-ahead situation and an acceleration-deceleration situation of the vehicle, and
estimating the mass of the vehicle includes:
updating the plurality of weights when the vehicle is traveling straight and accelerating or decelerating; and
maintaining the plurality of weights when the vehicle is neither traveling straight, nor accelerating, nor decelerating.

13. The device of claim 11, wherein the vehicle includes a tractor unit and a trailer unit, and
calculating the reference longitudinal force for each mass change includes calculating the reference longitudinal force for each mass change using a mass of the tractor unit and a mass of the trailer unit as a constant and a variable, respectively.

14. The device of claim 11, wherein the one or more programs further include an instruction for estimating a longitudinal tire force of the vehicle and an air resistance of the vehicle, and
the force received by the vehicle in the longitudinal direction includes the longitudinal tire force of the vehicle and the air resistance of the vehicle.

15. The device of claim 14, wherein estimating the longitudinal tire force of the vehicle and the air resistance of the vehicle includes:
estimating the longitudinal tire force of the vehicle based on a wheel speed value sensed by a four-wheel speed sensor of the vehicle, a driving torque value sensed by a driving torque sensor of the vehicle, and a braking torque value sensed by a braking torque sensor of the vehicle; and
estimating the air resistance of the vehicle based on a speed of the vehicle.

16. The device of claim 11, wherein the one or more programs further include an instruction for:
estimating a suspension pitch angle by collecting a value corresponding to an actual speed of the vehicle in values corresponding to respective speeds of the vehicle in a prestored map, and a value obtained by applying a low-pass filter to a longitudinal acceleration value sensed by a longitudinal acceleration sensor of the vehicle; and
correcting the longitudinal acceleration value by adding a product of the suspension pitch angle and a gravitational acceleration to the longitudinal acceleration value sensed by the longitudinal acceleration sensor of the vehicle,
wherein the suspension pitch angle is an angle between a road surface supporting tires of the vehicle and a suspension of the vehicle, and
the longitudinal acceleration value of the vehicle used in estimating the mass to update the plurality of weights is the corrected longitudinal acceleration value.

17. A vehicle comprising the computing device of claim 1.

18. A vehicle comprising the computing device of claim 11.
